(19) United States
(12) Patent Application Publication
(10) Pub. No.: US 2003/0233184 A1
(43) Pub. Date: Dec. 18, 2003

(54) Apparatus to control and actuate the gripping forces for loads to be carried by means of lift trucks or the like

(76) Inventor: Davide Roncari, S. Martino (IT)

Correspondence Address: NOTARO AND MICHALOS, 100 DUTCH HILL ROAD, SUITE 110, ORANGEBURG, NY, 10962-2100, US

(21) Appl. No.: 10/449,050

(22) Filed: May 30, 2003

(30) Foreign Application Priority Data
Jun. 12, 2002 (IT) VR2002 A 000065

(51) Int. Cl. G06G 7/00

(52) U.S. Cl. 701/50; 701/1

(57) ABSTRACT

The present apparatus detects the working pressure of the gripping forces for the arms in lift trucks, in particular the arms that permit to grip one or more prismatic packages or parcels with a lateral grip.

In general, the present system is provided with a series of sensors (9) arranged in a suitable manner on the inner surface of plates (7, 8) according to an arrangement that permits to exactly detect both the position and shape of the package or packages to be transported as well as a laser guide sensor (10).

### DESCRIPTION

The present invention proposes an apparatus to control and actuate the working pressures and/or gripping forces of the jaws and/or gripping components in lift trucks or the like that permit to lift and move loads, in particular electrical household appliances, in warehouses and storehouses. The apparatus in question detects the working pressures of the gripping forces of the arms in lift trucks, in particular the arms that permit to grip one or more prismatic packages or parcels with a lateral gripping.

This invention is useful above all to store and move both big electrical household appliances such as refrigerators, dish-washing machines, washing-machines and small electrical household appliances such as micro-wave ovens, televisions, and any squared package or parcel to be supported alone or togegher with other packages.

As is known, the lift trucks are self-moving machines which are utilized to move and displace packages or parcels in storehouses or warehouses of any kind.

It is also known that the front part of the said lift trucks is provided with jaws and/or sectors which permit to grip the packages or parcels to be moved.

The said jaws and/or sectors may show different shapes and equipments according to the kind of packages to be moved. For instance, the lift trucks may include the necessary equipments to carry either rolls or bales or electrical household appliances, fork equipments, rotating and overturning devices, pallet load equipments and pallet removers, equipments for carrying either cement articles or drums and other equipments.

Concerning the lift trucks utilized to grip and move electrical household appliances, the producers indicate on the packing of these appliances the maximum compression ratio data that it is possible to reach with the gripping components.

For the lifting of the packages or parcels the operator must set manually the pressure parameters required to safely grip and move them in such a way as not to damage them and prevent them from sliding down during the transport.

It is evident that there is a real difficulty in setting the said parameters with precision on taking into account that more packages may be placed side by side on the lift truck.

The object of the present invention is to conceive and carry out a control system to be mounted on the lifting equipment of lift trucks, in particular on the equipment fro the lateral grip and movement of electrical household appliances, which system detects the position and shape of the parcel to be displaced and turns the position and shape data into corresponding pressure signals fro hydraulic and/or pneumatic actuating means to actuate the gripping sectors and/or jaws.

An immediate advantage of the system according to the present invention is to permit the operator to have a simple and safe control on the lift truck since the strength of the grip is secured by a direct automated automatic control system which calculates the pressure value depending on the volume to be transported.

All the above objects and advantages are reached according to the present invention through an apparatus which controls and actuates the working pressures of the gripping sectors and/or jaws in lift trucks or the like, which sectors and/or jaws lift and displace prismatic loads, in particular electrical household appliances or the like, characterized in that the load gripping components consisting of opposite vertical plates moving horizontally are provided with a detecting system provided with sensors, the sensors being photo-electric cells or the like, which sensors are arranged on the surface of at least one of the plates according to the shape and size of the load or parcel to be transported, and that the said sensors detect the load position and shape and transmit signals to a PLC data processor provided with a pre-set table, which data processor turns the processed signals into pressures of the gripping plates of the lift truck in proportion to the detected shape and size.

Further features of the present invention will be better understood from the following description given as a non-limiting example on the hand of the accompanying drawings wherein:

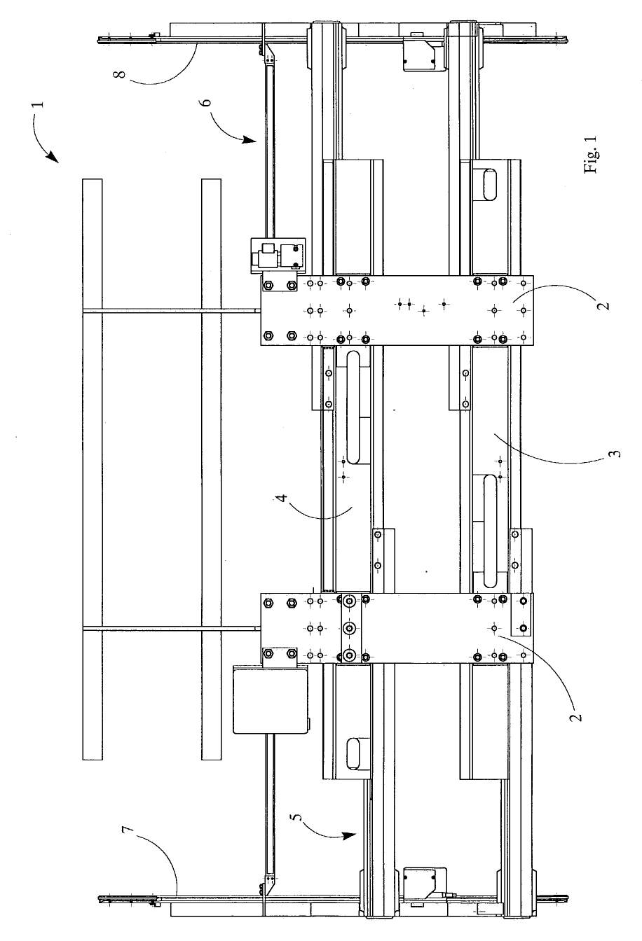

FIG. 1 is a schematical view of the rear side of the gripping unit of a lift truck according to the invention for the transport of packets or parcels, in particular containing electrical household appliances;

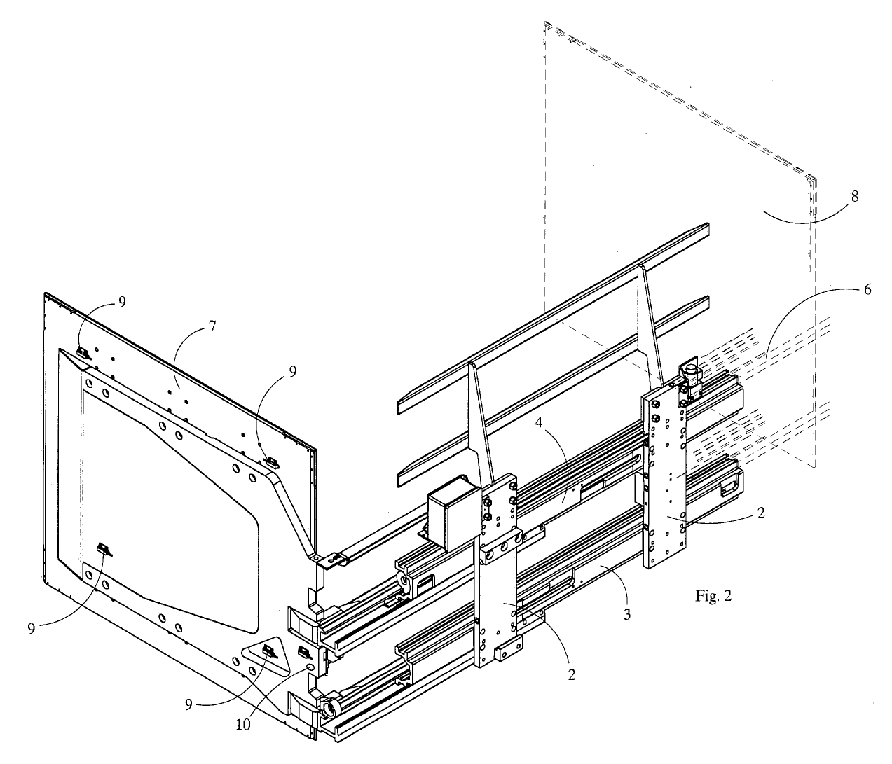

FIG. 2 is a schematical perspective view of the same.

With reference to the accompanying drawings, number 1 denotes a gripping unit of a lift truck on the whole. The gripping unit is to grip, lift and carry squared loads or packages such as packages containing big or small electrical household appliances.

Generally, the gripping unit 1 consists of a coupling structure which is coupled with the lift truck. The said structure consists of a pair of vertical supports 2 which are fixed to the front side of a lift truck.

The gripping unit 1 is provided with horizontal supports 3 and 4 on which two horizontally sliding units 5 and 6 are arranged. The sliding units 5 and 6 slide transversely to the front part of the vehicle and move in two opposite directions on getting away and near each other.

There are provided load gripping sectors and/or jaws having a sufficient area to grip the loads or packages to be transported.

The said gripping sectors and/or jaws are two vertical plates 7 and 8. A first vertical plate 7 is fixed to the end of a horizontally sliding unit 5 while a second vertical plate 8 is fixed to the end of a horizontally sliding unit 6.

The vertical plates 7 and 8 face each other and have the same area. They are symmetric and specular to the barycentre of the lift truck on which the plates are mounted.

The loads or packages to be transported are gripped by the said plates laterally. The vertical plates 7 and 8 are provided with suitable anti-slip gaskets. The gripping and keeping of the load or package is made possibile through equal contrary thrusts of pistons in the horizontal supports 3 and 4.

When the load has to be gripped and kept, the plates 7 and 8 are brought near each other. When the load is to be laid down on the floor or a suitable support, the plates 7 and 8 are brought far from each other.

The peculiarity of the present invention is a system that controls and actuates the working pressures of the gripping plate-shaped sectors and/or jaws 7 and 8. This system permits to automatically calculate the working pressures of the plates for the lifting of loads, in particular packages containing prismatic electrical household appliances or the like. This system is provided with a series of sensors 9 disposed on the inner surface of the plates 7 and 8 according to arrangements which permit to exactly detect both the position and shape of the package and/or packages to be carried. In addition, the present system is provided with a laser guide sensor 10.

The said sensors are photoelectric cells or components emitting infra-red rays or the like and detect the position and shape of the load or package to be carried or transported according to its position in respect to the plates. Then, the sensors transmit signals to a PLC processor provided with a pre-set table. Thus, the signals are processed and turned into working pressures of the gripping plates of the lift truck according to the detected shape and size.

In other words, the present system detects with precision the position and shape of the package to be lifted in such a way that all the signals are received instantaneously by a PLC processor which processes the signals according to pre-set tables.

The PLC processor processes the received signals and turns the processed data into corresponding proportional pressure impulses for the pistons which actuate the plates.

Thus, in proportion to the shape and size of the package to be transported the PLC processor orders a suited pressure for the plates which will move near each other so as to grip and lift the package in question.

As said, the sensors 9 are disposed on the plates and utilize a technology based on the reflection with photoelectric cell or infra-red rays addressed to the opposite gripping plate to determine the width of the package and/or packages with the utmost precision and calculate its/their position and shape exactly.

The laser guide sensor 10 is provided to detect the distance between the plates.

The packages to be transported may be more than one; it is sufficient to arrange them side by side to permit a multiple load and the present invention is especially useful in this case.

For an utilization of the so-described system it is sufficient to insert the package or packages to be transported between the plates 7 and 8 and actuate the moving of the plates closer each other so that they can touch the package.

In this phase of the gripping plates in which they move closer each other, the sensors 9 provided on the inner side of the gripping plates detect the position and shape of the package and then, the PLC system controls the working pressure for the gripping plates to move closer each other, this pressure being sufficient to permit the plates to lift and carry one or more loads.

The arrangement of the sensors will depend on the shape of the packages or loads taking into account that the sensors detect a surrounding area.

Advantageously, there is at least a proportional valve which controls the pistons mechanically for the displacement of the plates.

A technician of the field can make modifications and changes in the so-described invention and obtain solutions which are to be considered as included in the scope of protection of the invention which is further defined, in its peculiarities, in the following claims.

1. Apparatus for the controlling and actuating of the working pressures of the gripping sectors and/or jaws in lift trucks and/or similar machines for the lifting of prismatic loads, in particular electrical household appliances, including the load gripping components consisting of opposite vertical plates moving horizontally, characterized in that the load gripping components are provided with a detecting system provided with sensors (9), the sensors being photo-electric cells or infra-red ray sensors or the like, which sensors are arranged on the surface of at least one of the plates (7, 8) according to the shape and size of the load or parcel to be transported, and that the said sensors (9) detect the load position and shape and transmit signals to a PLC data processor provided with a pre-set table, which data processor turns the processed signals into pressures of the gripping plates (7, 8) of the lift truck in proportion to the detected shape and size.

2. Apparatus for the controlling and actuating of the working pressures of the gripping sectors and/or jaws in lift trucks and/or the like as claimed in the foregoing claim, characterized in that there are provided load gripping sectors and/or jaws having a sufficient area to grip the loads or packages to be transported, the said gripping sectors and/or jaws being two vertical plates (7, 8) in which a first vertical plate (7) is fixed to the end of a horizontally sliding unit (5) while a second vertical plate (8) is fixed to the end of a horizontally sliding unit (6).

3. Apparatus for the controlling and actuating of the working pressures of the gripping sectors and/or jaws in lift trucks and/or the like as claimed in the foregoing claims, characterized in that the loads or packages to be transported are gripped by the said plates (7, 8) laterally, which plates are provided with suitable anti-slip gaskets while the gripping and keeping of the load or package is made possibile through equal contrary thrusts of pistons in the horizontal supports (3, 4).

4. Apparatus for the controlling and actuating of the working pressures of the gripping sectors and/or jaws in lift trucks and/or the like as claimed in the foregoing claims, characterized in that a system controls and actuates the working pressures of the gripping plate-shaped sectors and/or jaws (7, 8), which system permits to automatically calculate the working pressures of the plates for the lifting of loads, in particular packages containing prismatic electrical household appliances or the like.

5. Apparatus for the controlling and actuating of the working pressures of the gripping sectors and/or jaws in lift trucks and/or the like as claimed in the foregoing claims, characterized in that this system is provided with a series of sensors (9) disposed on the inner surface of the plates (7, 8) according to arrangements which permit to exactly detect both the position and shape of the package and/or packages to be transported.

6. Apparatus for the controlling and actuating of the working pressures of the gripping sectors and/or jaws in lift trucks and/or the like as claimed in the foregoing claims, characterized in that the said sensors detect the position and shape of the packages according to the position of the gripping plates (7, 8) and transmit the signals to a PLC processor provided with a pre-set table so that the processed signals are turned into pressures for the gripping plates of the lift truck in proportion to the detected volume.

7. Apparatus for the controlling and actuating of the working pressures of the gripping sectors and/or jaws in lift trucks and/or the like as claimed in the foregoing claims, characterized in that the said sensors (9) utilize a technology based on the reflection with photoelectric cell or infra-red rays or a reflection with laser guide (10) to determine the shape and position of the package and/or packages with the utmost precision and calculate the force and relative gripping pressure of the plates (7, 8) exactly.

8. Apparatus for the controlling and actuating of the working pressures of the gripping sectors and/or jaws in lift trucks and/or the like as claimed in the foregoing claims, characterized in that the said PLC processor processes the received signals and turns the processed data into corresponding proportional pressure impulses for the pistons to actuate the movement of the plates (7, 8).

9. Apparatus for the controlling and actuating of the working pressures of the gripping sectors and/or jaws in lift trucks and/or the like as claimed in the foregoing claims, characterized in that there is at least a proportional valve to control the mechanical motion of the pistons to actuate the movement of the plates (7, 8).
